(19) United States
(12) Patent Application Publication
(10) Pub. No.: US 2025/0037048 A1
(43) Pub. Date: Jan. 30, 2025

(54) SYSTEM AND METHOD FOR PROVIDING A CUSTOMIZED SOLUTION FOR A PREDEFINED PROBLEM

(71) Applicant: JIO PLATFORMS LIMITED, Ahmedabad (IN)

(72) Inventors: Akansha KUMAR, Hyderabad (IN); Ameya MUNAGEKAR, Mumbai (IN); Kamlesh DHONDGE, Pune (IN)

(73) Assignee: JIO PLATFORMS LIMITED, Ahmedabad (IN)

(21) Appl. No.: 18/713,599

(22) PCT Filed: Nov. 26, 2022
(86) PCT No.: PCT/IB2022/061446

§ 371 Date: May 24, 2024

(30) Foreign Application Priority Data
Nov. 26, 2021 (IN) 202121054663

(51) Int. Cl. G06Q 10/0631; G06Q 10/04

(52) U.S. Cl. CPC G06Q 10/06311; G06Q 10/04

(57) ABSTRACT

The present invention provides a robust and effective solution to an entity or an organization by enabling them to implement a system for that provides a one-stop template-based system and method for optimization solutions in supply chain, distribution network, services, scheduling and delivery systems. The system enables business decision makers, planners and other non-technical users in designing their optimization use case, choosing the constraints, identifying the variables and methods, and executing the problem to obtain the solution. A user interface associated with the system can be deployed in the cloud. A user needs to choose a set of attributes such as pre-defined template, select the necessary constraints, choose the type of formulation and the tool and then upload the data in the predefined templates. Once uploaded, the user can submit the set of attributes to execute the system and obtain the results in a dashboard associated with the system.

### RESERVATION OF RIGHTS

A portion of the disclosure of this patent document contains material, which is subject to intellectual property rights such as, but are not limited to, copyright, design, trademark, IC layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner. Further, the patent document also proposes new network interface protocols that will contribute to the 3GPP Technical Specification (TS) for future generation network technologies (6G networks).

### FIELD OF INVENTION

The embodiments of the present disclosure generally relate to process automation and planning of distribution networks. More particularly, the present disclosure pertains to optimization applied to supply chain, distribution network, services, scheduling and delivery systems.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In today's technology world, maximizing productivity by reducing uncertainties is the top priority across industries. Mounting expectations of speed and efficiencies between suppliers and business partners creates a demand for efficient systems across multiple domains. Over the last thirty years, the supply industry has undergone a tremendous change to ensure the supply of production lines and delivery to customers, to become an independent supply chain management function. Various optimization strategies are employed to support the independent supply chain management functions.

However, the optimization strategies are lost in the shuffle of ecommerce organizations. With the full-time responsibility of managing sales targets, acquisition rates, promotions and conversion, there is little time to be spent digging into data Moreover, existing optimization platforms lack the process of formulating and optimization with minimal technical involvement. Additionally, existing platforms lack the customization of optimization platforms with user specific needs in the supply chain, distribution network, services, scheduling and delivery systems.

Therefore, there is a need for a system and method that can address the problem of customizing optimization solutions and mitigate the limitations in the art.

### OBJECTS OF THE PRESENT DISCLOSURE

Some of the objects of the present disclosure, which at least one embodiment herein satisfies are as listed herein below.

It is an object of the present disclosure to provide a system and a method to facilitate a one-stop place for customizing optimization solutions for various entities.

It is an object of the present disclosure to provide a system and a method to facilitate delivery planning, order scheduling, inventory optimization and product allocation.

It is an object of the present disclosure to provide a system and a method to enable business decision makers, planners and other non-technical users to solve optimization problems in the supply chain, distribution network, services, scheduling and delivery systems.

It is an object of the present disclosure to provide a system and a method to enable a non-optimization and non-operation research user to solve optimization problems in the supply chain, distribution network, services, scheduling and delivery systems.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides an optimized platform (system) for providing a customized solution for a predefined problem. The system may include one or more processors operatively coupled to a plurality of computing devices, the one or more processors may be coupled with a memory that may store instructions which when executed by the one or more processors cause the optimized platform to receive one or more input parameters using a predefined template. The one or more users may be associated with an entity and operate through the plurality of computing devices connected to each other through a network. The optimized platform may extract a first set of attributes from the one or more input parameters, the first set of attributes pertaining to predefined constraints provided by the one or more users for the entity. The optimized platform may extract a second set of attributes based on the first set of attributes, the second set of attributes pertaining to one or more techniques associated with the problem, selected by the one or more users for the entity. The optimized platform may extract a third set of attributes based on the second set of attributes, the third set of attributes pertaining to one or more tools associated with the one or more techniques, selected by the one or more users for the entity. Based on the first set of attributes, the second set of attributes and the third set of attributes, the optimized platform may generate an optimized model through an AI engine. The AI engine may be configured to use the one or more tools and the one or more techniques. The optimized platform may auto-recommend, the customized solution for the predefined problem, based on the optimized model.

In an embodiment, the optimized platform may generate an authentication token to enable the one or more users to access the predefined template.

In an embodiment, the AI engine may include any or a combination of Linear program (LP), Mixed Integer Programming (MIP), Quadratic Programming (QP) and metaheuristics (MH).

In an embodiment, the one or more tools used by the AI engine (216) include any or a combination of Genetic Algorithms (GA) and Simulated Annealing (SA) to execute the one or more techniques.

In an embodiment, the optimized platform may be configured to classify the one or more input parameters into a problem type associated with the problem using the one or more tools and the one or more techniques.

In an embodiment, the optimized platform may be further configured to enable the one or more users to add an additional set of parameters with the one or more input parameters to generate a customized template, wherein the additional set of parameters pertain to additional constraints provided by the one or more users for the entity.

In an embodiment, the optimized platform may be further configured to use the customized solution to optimize a set of routes for a fleet of heterogeneous vehicles for the entity.

In an embodiment, the optimized platform may be further configured to use the customized solution to allocate resources for the entity.

In an embodiment, the optimized platform may be further configured to use the customized solution to schedule a task for the entity based on the additional constraints through the customized template.

In an embodiment, the optimized platform may be further configured to use the customized solution to minimize the cost and achieve the desired product blend for the entity.

In an embodiment, the optimized platform may be configured to use the customized solution to maximize profitability while creating a product assortment for the entity.

In an embodiment, the optimized platform may be configured to use the customized solution to minimize the cost of packing materials for a given set of products for the entity.

In an embodiment, the optimized platform may be configured to operate in an asynchronous mode to enable the one or more users to access the predefined template and generate the customized solution, through an API. The optimized platform may also be configured to operate in an asynchronous mode enable the one or more users to access the customized template and generate a modified customized solution, through the API.

In an embodiment, the optimized platform may be configured to record the one or more input parameters and enforce validation, authentication, rate limiting and logging metrics for the one or more input parameters. The optimized platform may be configured to bifurcate the one or more input parameters and assign custom data structures to the one or more input parameters based on the problem type. The optimized platform may be configured to create objects from the custom data structures to be integrated with the one or more tools to generate the customized solution.

In an embodiment, the one or more input parameters may pertain to any or a combination of supply chain, distribution network, services, scheduling and delivery systems.

In an embodiment, the entity may include any or a combination of goods transport, retail offline, online organisation, telecom, hydrocarbons retail, manufacturing and polymer industry, and healthcare.

In an aspect, the present disclosure provides a user equipment (UE) for generating recommendation for providing input services. The UE may include one or more processors, the one or more processors may be coupled with a memory that may store instructions which when executed by the one or more processors and cause the UE to receive one or more input parameters from the one or more users using a predefined template. The UE may also be communicatively coupled to an optimized platform and may transmit the predefined template populated with the one or more input parameters to the optimized platform. The UE may also receive the customized solution for the predefined problem from the optimized platform. The optimized platform may extract a first set of attributes from the one or more input parameters, the first set of attributes pertaining to predefined constraints provided by the one or more users for the entity. The optimized platform may extract a second set of attributes based on the first set of attributes, the second set of attributes pertaining to one or more techniques associated with the problem, selected by the one or more users for the entity. The optimized platform may extract a third set of attributes based on the second set of attributes, the third set of attributes pertaining to one or more tools associated with the one or more techniques, selected by the one or more users for the entity. Based on the first set of attributes, the second set of attributes and the third set of attributes, the optimized platform may generate an optimized model through an AI engine. The AI engine may be configured to use the one or more tools and the one or more techniques. The optimized platform may auto-recommend, the customized solution for the predefined problem, based on the optimized model.

In an aspect, the present disclosure provides a method for providing a customized solution for a predefined problem. The method may include the step of receiving, by one or more processors, one or more input parameters from one or more users using a predefined template. The one or more processors may be operatively coupled to a plurality of computing devices, and coupled with a memory. The memory of the processor may store instructions to be executed by the one or more processors. The one or more users may operate through a plurality of computing devices and be connected through a network. The method may further include the step of extracting, by the one or more processors a first set of attributes from the one or more input parameters where the first set of attributes may pertain to predefined constraints provided by the one or more users for an entity. The method may further include the step of extracting, by the one or more processors a second set of attributes based on the first set of attributes. The second set of attributes may pertain to one or more techniques associated with a problem type, selected by the one or more users for the entity. The method may further include extracting, by the one or more processors, a third set of attributes based on the second set of attributes. The third set of attributes may pertain to one or more tools associated with the one or more techniques, selected by the one or more users for the entity. The method may further include the step of generating by the one or more processors based on the first set of attributes, the second set of attributes and the third set of attributes, an optimized model through an AI engine. The AI engine may be configured to use the one or more tools and the one or more techniques to generate an optimized model. Further, the method may also include auto-recommending, by the one or more processors a customized solution to provide an optimization platform across a plurality of domains, based on the optimized model.

In an aspect, method for providing a customized solution for a predefined problem may further include the step of recording, by the one or more processors, the one or more input parameters. The method may also include the step of enforcing, by the one or more processors, validation, authentication, rate limiting and logging metrics for the one or more input parameters. The method may also include the step of bifurcating, by the one or more processors, the one or more input parameters. Additionally, the method may also include the step of assigning, by the one or more processors, custom data structures to the one or more input parameters based on the problem type. Further, the method may also include the step of generating, by the one or more processors, objects from the custom data structures to be integrated with the one or more tools to generate the modified customized solution.

In an embodiment, the method for providing a customized solution for a predefined problem by the optimized platform may include the one or more techniques with any or a combination of Linear program (LP), Mixed Integer Programming (MIP), Quadratic Programming (QP) and metaheuristics (MH) used by the AI engine.

In an embodiment, the method for providing a customized solution for a predefined problem by the optimized platform may include the one or more tools with any or a combination of combination of Genetic Algorithms (GA) and Simulated Annealing (SA) by the AI engine to execute the one or more techniques.

In an embodiment, the method for providing a customized solution for a predefined problem by the optimized platform may include the one or more input parameters pertaining to any or a combination of supply chain, distribution network, services, scheduling and delivery systems.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture (100) in which or with which the system of the present disclosure can be implemented, in accordance with an embodiment of the present disclosure.

FIG. 2 illustrates an exemplary representation (200) of the optimized platform (110), in accordance with an embodiment of the present disclosure.

FIG. 3 illustrates an exemplary block diagram (300) representation depicting a macroscopic view of the optimized platform (110), in accordance with an embodiment of the present disclosure.

FIG. 4 illustrates an exemplary representation (400) of a delivery mechanism and its implementation, in accordance with an embodiment of the present disclosure.

FIG. 5 illustrates an exemplary representation (500) of an HLD component, in accordance with an embodiment of the present disclosure.

FIG. 6 illustrates an exemplary representation (600) of an LLD of the system (110) in accordance with an embodiment of the present disclosure.

FIG. 7 illustrates an exemplary representation (700) of a sequence or signal flow diagram, in accordance with an embodiment of the present disclosure.

FIGS. 8A-8I illustrate exemplary representations of user interface (UI) screens, in accordance with an embodiment of the present disclosure.

FIG. 9 illustrates an exemplary computer system (900) used in accordance with an embodiment of the present disclosure.

The foregoing shall be more apparent from the following more detailed description of the invention.

### BRIEF DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

The present invention provides a robust and effective solution to an entity or an organization by enabling them to implement a system/platform that provides a one-stop template-based system and method for optimization solutions in supply chain, distribution network, services, scheduling and delivery systems. The system enables business decision makers, planners and other non-technical users in customizing optimization solutions. A user interface associated with the platform/system can be deployed in the cloud for providing solutions. A user needs to choose a set of attributes such as pre-defined template, select the necessary constraints, choose the type of formulation and the tool and then upload the data in the predefined templates. Once uploaded, the user can submit the set of attributes to execute the platform/system and obtain the results in a dashboard associated with the platform/system. In an embodiment, the system may provide customization using at least 20 pre-defined templates, at least 7 types of problem domains and at least 5 types of tools and frameworks. The customization leads to at least 200 odd business usable templates. The system further can enable a non-optimization and non-operation research user to solve optimization problems in the supply chain, distribution network, services, scheduling and delivery systems.

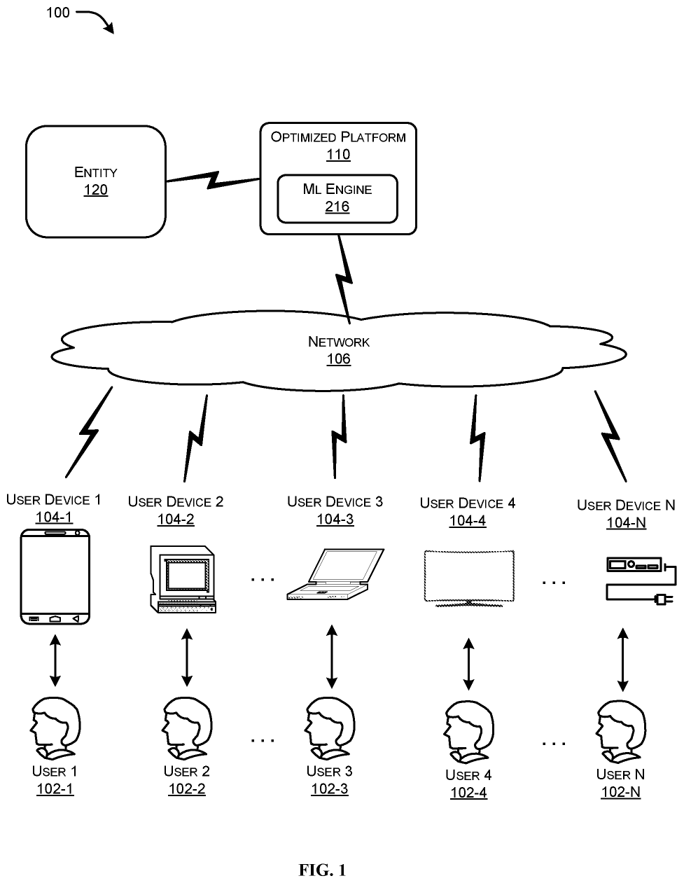

Referring to FIG. 1 that illustrates an exemplary network architecture of an optimized platform (110) in accordance with an embodiment of the present disclosure. As illustrated in FIG. 1, by way of example but not limitation, the optimized platform (110) may include one or more users (102-1, 102-2, . . . 102-n) hereinafter interchangeably referred as user or client and collectively referred to as users (102) associated with at least one computing device (104-1, 104-2, . . . 104-n) (hereinafter interchangeably referred as a smart computing device; and collectively referred to as computing devices (104)). The users (102) may interact with the optimized platform (110) by using their respective computing devices (104). In an embodiment, the users (102) may be associated with an entity (120). The computing devices (104) and the optimized platform (110) may communicate with each other over a network (106).

In an embodiment, the computing devices (104) may communicate with the optimized platform (110) through set of executable instructions residing on any operating system, including but not limited to, Android™, iOS™, Kai OS™ and the like. In an embodiment, the computing devices (104) may include, but not limited to, any electrical, electronic, electro-mechanical or an equipment or a combination of one or more of the above devices such as mobile phone, smartphone, virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen and the like. It may be appreciated that the computing devices (104) may not be restricted to the mentioned devices and various other devices may be used.

The optimized platform (110) can be equipped with an artificial intelligence (AI) engine (216) for facilitating optimization of a set of input parameters for the entity (120). The set of input parameters can be associated with supply chain, distribution network, services, scheduling and delivery systems. The optimization platform (110) may be configured to receive the set of input parameters pertaining to an entity (120). In an embodiment, the entity (120) may include a goods transport, retail offline/online organisation, telecom, hydrocarbons retail, manufacturing and polymer industry, healthcare, and the like.

Further, the network (106) can be a wireless network, a wired network, a cloud or a combination thereof that can be implemented as one of the different types of networks, such as Intranet, BLUETOOTH, MQTT Broker cloud, Local Area Network (LAN), Wide Area Network (WAN), Internet, and the like. Further, the network 106 can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), and the like. In an exemplary embodiment, the network (106) can be an HC-05 Bluetooth module which is an easy to use Bluetooth SPP (Serial Port Protocol) module, designed for transparent wireless serial connection setup

In an embodiment, the optimized platform (110) may include one or more processors (202) operatively coupled to the computing devices (104). The one or more processors (202) may be coupled with a memory (204) that stores instructions. The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

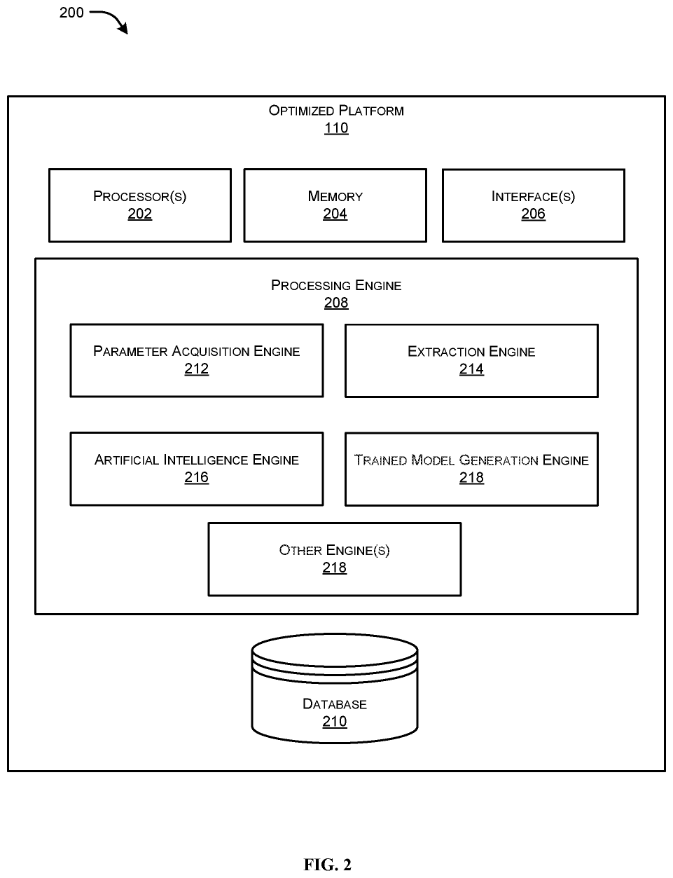

Referring to FIG. 2, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208).

The processing engine (208) may include one or more engines selected from any of a parameter acquisition engine (212), an extraction engine (214), an artificial intelligence (AI) engine (216), a trained model generation engine (218) and other engines (220). The processing engine (208) may also include one or more interface(s) (206), for data input and output devices, collectively referred to as I/O devices, storage devices, and the like. The interface(s) (206) may facilitate communication of the optimized platform (110).

In an embodiment, the parameter acquisition engine (212) may be configured to generate the predefined template and send it to the computing device (104). The predefined template is presented to the users (102) through the user interface. The users (102) may access the predefined template and populate one or more fields to indicate the constraints. The parameter acquisition engine (212) may be configured to receive the populated predefined template and store it in the database (210).

The extraction engine (214) may be configured to retrieve the predefined template and extract a first set of attributes from the one or more input parameters. The first set of attributes may pertain to predefined constraints provided by the one or more users (102) for the entity (120). The extraction engine (214) may be configured to extract a second set of attributes based on the first set of attributes pertaining to techniques associated with the problem and selected by the users (102) for the entity (120). The extraction engine (214) may be configured to extract a third set of attributes based on the second set of attributes pertaining to the tools associated with the techniques, selected by the users (102) for the entity (120).

The AI engine (216) may be configured to use the first set of attributes, the second set of attributes and the third set of attributes and send it to the trained model generation engine (218). The trained model generation engine (218) may use generate an optimized model based on the first set of attributes, the second set of attributes, the third set of attributes. The AI engine (216) may, based on the optimized auto-recommend, the customized solution for the predefined problem.

According to various embodiments of the present disclosure, the optimized platform/system (110) can provide a customized solution for the predefined problem using an AI engine (216). In an illustrative embodiment, the one or more techniques (herein after referred as techniques) used by the AI engine (216) can include, but not limited to, Linear program (LP), Mixed Integer Programming (MIP), Quadratic Programming (QP) or metaheuristics (MH) or a combination thereof. The users (102) may provide the one or more input parameters associated with the problem through the predefined template presented to the users (102) and select the techniques amongst the plurality of techniques. Additionally, the users (102) may also select the one or more tools (herein after referred as tools) for executing/implementing the techniques and obtain a customized solution for the predefined problem. The predefined problem pertains to the problem type associated with the problem for the entity (120).

In an embodiment, the optimized platform (110) may generate an authentication token to enable the users (102) to access the predefined template. By way of example and not as a limitation, a web-based user interface may be built using but not limited to React JS and hosted on a cloud. It may interact with the backend system through REST APIs. The users (102) need to have an authentication token for selecting a template, customizing the templating and submitting it for execution.

In an embodiment, the optimized platform (110) may receive one or more input parameters from the users (102) using the predefined template, where the users (102) may operate through the plurality of computing devices (104) connected to each other through a network (106). In an embodiment, the optimized platform (110) may generate an authentication token to enable the users (102) to access the predefined template through the computing devices (104).

In an embodiment, the optimized platform (110) may extract a first set of attributes from the one or more input parameters, the first set of attributes pertaining to predefined constraints provided by the users (102) for the entity (120). For example, a vehicle routing problem may be provided by the entity (120) such as the vehicle routing organization, where the predefined constraints may include capacity of the vehicle, time window and pick/delivery constraints.

In an embodiment, the optimized platform (110) may extract a second set of attributes based on the first set of attributes, the second set of attributes pertaining to one or more techniques (herein after referred as techniques) associated with the problem, selected by the one or more users (102) for the entity (120). For example, the users (102) may select among the techniques that include any or a combination of Linear program (LP) (346), Mixed Integer Programming (MIP) (350, 352), Quadratic Programming (QP) (348) and metaheuristics (MH) (356).

In an embodiment, the optimized platform (110) may extract a third set of attributes based on the second set of attributes, the third set of attributes pertaining to the tools associated with the techniques, selected by the users (102) for the entity (120). For example, the users (102) may select the tools includes any or a combination of Genetic Algorithms (GA) and Simulated Annealing (SA) to execute the techniques. Based on the first set of attributes, the second set of attributes and the third set of attributes, the optimized platform (110) may generate an optimized model through an AI engine (216) and auto-recommend, the customized solution for the predefined problem.

In an aspect, the method for providing a customized solution for the predefined problem through the optimized platform (110) may include the step of receiving, by the one or more processors (202), one or more input parameters from users using (102) a predefined template. The one or more processors (202) may be operatively coupled to a plurality of computing devices (104), and coupled with the memory (204). The memory (204) of the processor (202) may store instructions to be executed by the one or more processors (202). The users (102) may operate through a plurality of computing devices (104) and be connected to the optimized platform (110) and connected to each other through the network (106). The method may further include the step of extracting, by the one or more processors (202) a first set of attributes from the one or more input parameters where the first set of attributes may pertain to the predefined constraints provided by the users (102) for an entity (120). The method may further include the step of extracting, by the one or more processors (202) a second set of attributes based on the first set of attributes. The second set of attributes may pertain to the one or more techniques associated with a problem, selected by the users (102) for the entity (120). The method may further include the step of extracting, by the one or more processors (202), a third set of attributes based on the second set of attributes. The third set of attributes may pertain to the one or more tools associated with the one or more techniques, selected by the users (102) for the entity (120). The method may further include the step of generating by the one or more processors (202) based on the first set of attributes, the second set of attributes and the third set of attributes, the optimized model through an AI engine (216). The AI engine (216) may be configured to use the tools and the techniques to generate an optimized model. Further, the method may also include the step of auto-recommending, by the one or more processors (202), the customized solution for the predefined problem, based on the optimized model.

In an embodiment, the method for providing a customized solution for a predefined problem through the optimized platform (110) may include the step of recording, the one or more input parameters, by the one or more processors (202). The method may include the step of enforcing validation, authentication, rate limiting and logging metrics for the one or more input parameters, by the one or more processors (202). The method may include the step of bifurcating the one or more input parameters, by the one or more processors (202). The method may include the step of assigning custom data structures to the one or more input parameters based on the problem type, by the one or more processors (202). The method may include the step of generating, objects from the custom data structures to be integrated with the one or more tools to generate the modified customized solution, by the one or more processors (202).

In an embodiment, the method for providing a customized solution for a predefined problem by the optimized platform (110) may include the one or more techniques with any or a combination of Linear program (LP), Mixed Integer Programming (MIP), Quadratic Programming (QP) and metaheuristics (MH) used by the AI engine.

In an embodiment, the method for providing a customized solution for a predefined problem by the optimized platform (110) may include the one or more tools with any or a combination of combination of Genetic Algorithms (GA) and Simulated Annealing (SA) by the AI engine to execute the one or more techniques.

In an embodiment, the method for providing a customized solution for a predefined problem by the optimized platform (110) may include the one or more input parameters pertaining to any or a combination of supply chain, distribution network, services, scheduling and delivery systems.

In an embodiment, the optimized platform (110) may classify the one or more input parameters into a problem type associated with the problem using the tools and the techniques. For example, the problem type could be a scheduling problem for maximizing the score of shift allocations involving workers with various shifts. Predefined constraints such as fixed number of workers for each shift, fixed number of days per worker and preferred work shifts may be provided by the users (102) and may be specific to an entity (120).

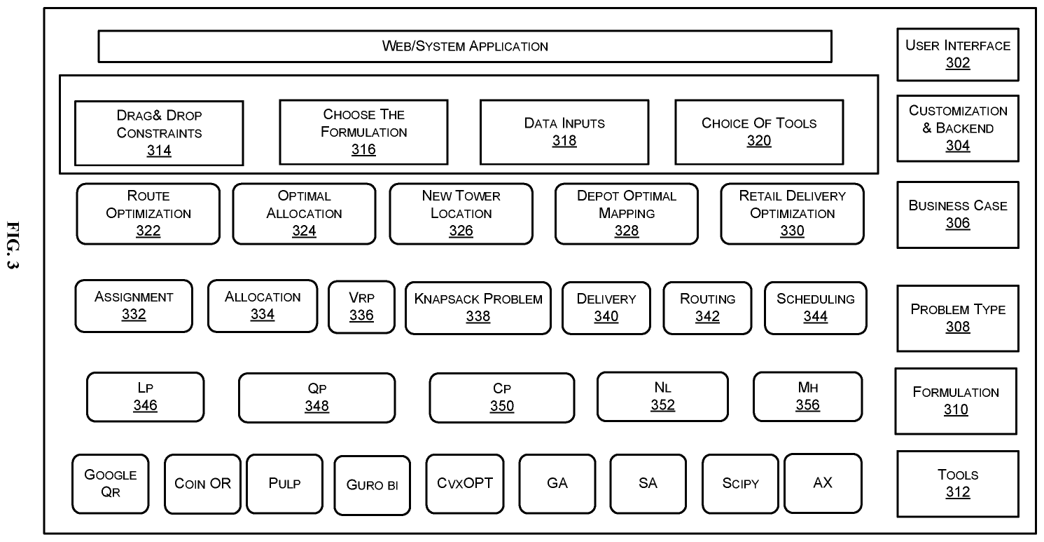

FIG. 3 illustrates exemplary block diagram representation depicting a macroscopic view of the system/optimized platform (110), in accordance with an embodiment of the present disclosure. As illustrated, in an aspect the macroscopic view (300) may include at least six components. In an exemplary embodiment, the at least six components may include a User Interface (302), Customization and Backend (304), Business Case (306), Problem Type (308), Formulation (310), Tools (312) and the like.

In an exemplary embodiment, the Customization and Backend module (304) located in the optimized platform (110) may enable the users (102) to select the problem and can add constraints to it based on the business needs.

In an exemplary embodiment, the Business Case module (306) may comprise of ready to use templates based on business use-cases. For example, a business case for the entity (120) may be to assign the right delivery personnel to deliver a product (330, 340) at a customer place or else identify the optimal routes (322, 342) to move products from the depots to the stores. Several such business cases can be made available as templates where the users (102) may need to provide the one or more input parameters through the predefined template on the optimized platform (110). Subsequently, the users (102) can choose the type of techniques and the tools to solve the predefined problem. For example, the users (102) can provide the distance matrix and the predefined constraints. In an embodiment, the predefined constraints can include capacity constraints of the vehicle, time constraints for delivery and pick-up/delivery constraints for the entity (120).

In an exemplary embodiment, the Problem Type module (308) may cater to a plurality of problem types in the optimization area such as Assignment (332), Allocation (334), Vehicle Routing Problem (VRP) (336), Knapsack (338), Delivery (340), Routing (342), and Scheduling (344), but not limited to the like. For example, the Assignment module (332) may assign a specific subject, person or worker to a specific task assuming that the number of persons/subjects equal to the number of tasks available.

In an embodiment, the optimized platform/system (110) may be configured to use the customized solution to allocate resources for the entity (120).

In an exemplary embodiment, the Allocation module (334) may involve the distribution of resources among competing alternatives in order to minimize the total costs or maximize the total return. Such a category of problems may have the following components: a set of resources available in given amounts; a set of jobs to be done, each consuming a specified number of resources and a set of cost or returns for each job and resource. The problem is to determine how much of each resource is to be allocated to each job. The VRP module (336) may help in finding the optimal set of routes for a fleet of heterogeneous vehicles to traverse in order to deliver to a given set of customers. The Knapsack module (338) may include, given a set of items, each with a weight and a value, determine the number of each item to include in a collection so that the total weight is less than or equal to a given limit and the total value is as large as possible. The problem often arises in resource allocation where the decision makers must choose from a set of non-divisible projects or tasks under a fixed budget or time constraint, respectively. The Scheduling module (344) may comprise of a fixed number of jobs and each job has its own parameters. The parameters may constitute tasks, any sequential constraints, time estimates for each operation and the required resources. In scheduling, the approaches may require some estimate of how long it takes to perform the work.

In an exemplary embodiment, the Formulation module (310) may convert a business/real-world problem into a mathematical equation which can be solved. In formulation all the components such as constraints, objectives and fitness/cost parameters are quantified and represented in a mathematical notation. In this artwork, such as Linear program (LP) (346), Mixed Integer Programming (MIP) (350), Quadratic Programming (QP) (348) and metaheuristics (MH) (356) are used.

In an exemplary embodiment, the Tools module (312) may integrate tools such as a couple of Python based custom built meta-heuristic methods including Genetic Algorithms (GA) and Simulated Annealing (SA) (356).

In an exemplary embodiment, the Mathematical Formulations may include Linear Programming (LP) which is an optimization method to minimize or maximize a particular objective which is linear in nature, given a set of linear relationships. In a linear programming model, the decision variables are continuous in nature. Further, Mixed integer programming (MIP) may also be implemented that is an optimization method to minimize or maximize a particular objective which is linear in nature, given a set of linear relationships. In MIP model, the decision variables can be continuous, integer or binary in nature, while a non-linear programming model is an optimization model to minimize or maximize a particular objective which is non-linear in nature. The constraint relations could be linear or non-linear in nature. In the natural language processing model (NLP) model, the decision variables can be continuous, integer or binary in nature. The Quadratic programming (QP) models are those which have quadratic terms in the objective function which need to be minimized or maximized. In QP, there are a set of linear relationships. Quadratic programming is a type of non-linear programming technique. While Metaheuristics are problem independent algorithms used to find a minima or a maxima of an objective function given a set of constraints. Both the objective function and the constraints can be non-linear in nature.

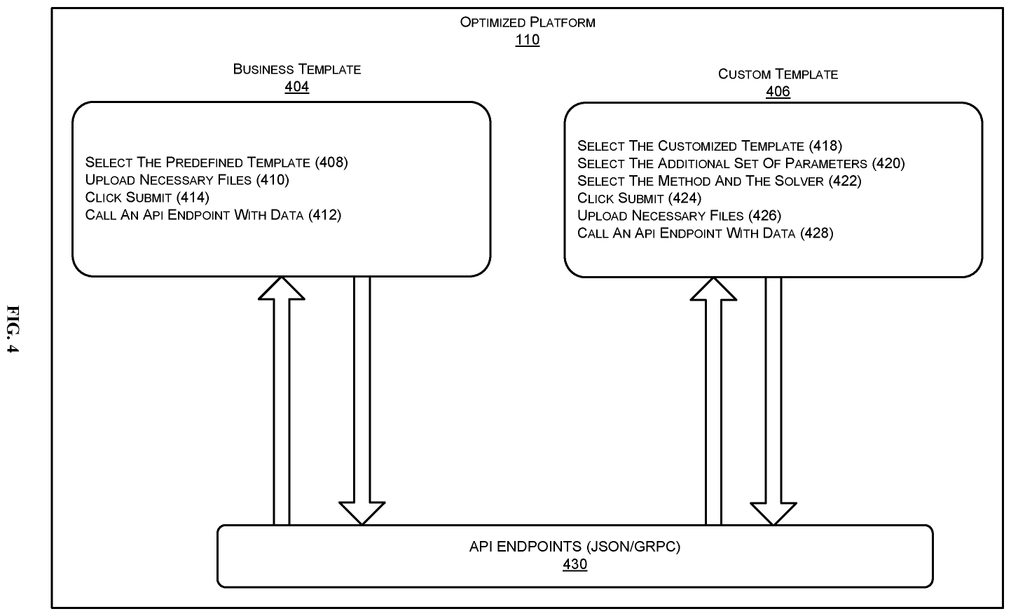

FIG. 4 illustrates an exemplary representation of a delivery mechanism (400) and its implementation, in accordance with an embodiment of the present disclosure. As illustrated, in an aspect, the delivery mechanism (400) may include a first user or a business user and a second user or a developer user (hereinafter referred as users (102) associated with the entity (120)). A predefined template (402) may be used/populated by the users (102) to obtain a customized solution through the optimized platform (110). Similarly, the customized template (404) may be used/populated by the users (102) to obtain the modified customized solution through the optimized platform (110).

In an exemplary embodiment, the users (102) may access the predefined template, upload the necessary files (410) and press submit (414). The optimized platform (110) may call an API endpoint with data (412) to provide the customized solution for the problem type. Additionally, the users (102) may access the customized template and add the additional set of parameters (420) to the customized template. The users (102) may also choose the tools (422) and upload the necessary files (426) and press submit (424). The optimized platform (110) may call an AP endpoint with data (428) to provide the modified customized solution for the problem type.

In an embodiment, the optimized platform (110) may be configured to use the customized solution to optimize a set of routes for a fleet of heterogeneous vehicles for the entity (120). For example, the VRP module (336) may help in finding the optimal set of routes for a fleet of heterogeneous vehicles to traverse in order to deliver to a given set of customers.

In an exemplary embodiment, the optimized platform (110) may generate Business Templates (404) that may include a last mile delivery problem with the objective of minimizing the distance travelled by all the available vehicles in order to service all the nodes. The Decision variables that may be required to decide which vehicle will serve which node and constraints may include.
Capacity constraints of the vehicles.
Time window constraints
Pickup and delivery constraints

In an exemplary embodiment, the optimized platform (110) may receive input parameters such as distance matrix, constraint specific parameters and the like and may provide an output as routes assigned to the vehicles.

In an embodiment, the optimized platform (110) may be configured to use the customized solution to schedule a task for the entity (120) based on the additional constraints through the customized template.

In an exemplary embodiment, the objective of Scheduling module (344) may include maximizing the score of the shift allocation. Decision variables may be required to decide which worker to be assigned to which shift. The predefined constraints of scheduling may include custom constraints and depend completely on the entity (120). Some of the predefined constraints may include:
Fixed number of workers each shift.
Fixed number of days a worker works in a week
Preferred work shifts for the workers

In an embodiment, the optimized platform (110) may be configured to use the customized solution to minimize the cost and achieve the desired product blend for the entity (120).

In an exemplary embodiment, the objective of the assignment module (332) may be to minimize the cost of assigning the ROs to the terminals. The decision variables may be required to decide as to which RO would be assigned to which terminal. The predefined constraints may include:
An RO can be assigned to only one terminal
A terminal can have only an upper bound on the number of ROs assigned to it

In an exemplary embodiment, the optimized platform (110) may receive input parameters as Terminal RO pair cost and provide output that can be assignment pairs.

In an embodiment, the optimized platform (110) may be configured to use the customized solution to maximize profitability while creating a product assortment for the entity (120).

In an exemplary embodiment, the objective of the product blending problem may be to minimize the cost of raw materials to achieve the desired product blends. Decision variables may be required to decide which product to use to make a particular product. The predefined constraints may include:
Maximum availability of the raw materials.
Minimum amount of products to be blended and manufactured

In an exemplary embodiment, the optimized platform (110) may receive input parameters as raw material parameters, product parameters and provide output as raw material product blends.

In an embodiment, the optimized platform (110) may be configured to use the customized solution to maximize profitability while creating a product assortment for the entity (120).

In an exemplary embodiment, the objective of the store assortment problem may be to create product assortment in the different stores in order to maximize the profitability. The decision variables may be required to decide which product should be allocated in which store. The predefined constraints may include:
Store capacities
Product parameters

In an exemplary embodiment, the optimized platform (110) may receive input parameters as the product parameters, store parameters and output the product assignment to the store.

In an embodiment, the optimized platform (110) may be configured to use the customized solution to minimize the cost of packing materials for a given set of products for the entity (120).

In an exemplary embodiment, the objective of the packing optimization problem may be to minimize the cost of packing materials for a given set of products. The decision variables can be required to decide which product to be packed in which bin. The predefined constraints may include:
Bin capacities
Custom Packing requirements

In an exemplary embodiment, the optimization platform (110) may receive input parameters as the product parameters and the bin parameters and Output them as Bin allocations of the products.

By ways of an example and not as limitations, the problem types may include:

### 1. Vehicle Routing Problem MIP Formulation

Sets: I, J=Set of all the nodes, K=Set of all the vehicle
Parameters: di,=Costoftravellingarci,j
Decision Variables: Xi,,={0,1}∀(i∈I, j∈J, k∈K)
Objective Function: Minimize ΣiΣjΣkdi,*Xi,j,k
Constraints:
   Vehicle leaves node that it enters
   ΣiXi,j,k=ΣiXj,i,k∀(j∈J, k∈K)
   Ensure that every node is entered once
   ΣkΣiXi,,=1∀j∈{2, . . . n}
   Every vehicle leaves depot
   Σnj=2×1,j,k=1∀k∈K
   A node cannot enter itself after exiting itself.
   Xi,j,k==0∀(i=j∀i∈I, j∈J;i≠0, j≠0),k∈K
   Subtour elimination constraint
   Σi∈S,∉SXi,j,k≥2S⊂V/{depot},2≤∥S∥≤n−2

### 2. Assignment MIP Formulation

Sets: I: set of jobs J: set of workers
Parameters: Cᵢⱼ: Cost of assigning a worker to a job
Decision variables: Xᵢⱼ={0,1}∀i in jobs, j in workers
   =1 if worker j is assigned to job i
   =0 otherwise
Objective function: Minimize Σ₍ᵢ₎Σ₍ⱼ₎Cᵢⱼ*Xᵢⱼ
Constraints: One job should have less than equal to one worker
   ΣᵢXᵢⱼ<=1∀j in workers
   if n(Workers)<=n(Jobs);
   ΣᵢXᵢⱼ==1∀i in workers
One worker should have less than equal to 1 job
   ΣⱼXᵢⱼ<=1∀i in jobs
   if n(jobs)<=n(workers);
   ΣⱼXᵢⱼ==1∀i in jobs

### 3. Assortment MIP Formulation

Sets: I: set of stores J: set of products
Parameters: Cᵢⱼ: Cost of assigning a product to a store
Decision variables: Xᵢⱼ={0,1}∀i in store, j in product
   =1 if product j is assigned to store i
   =0 otherwise
Objective function: Minimize Σ₍ᵢ₎Σ₍ⱼ₎Cᵢⱼ*Xᵢⱼ
Constraints:
Capacity of store
   ΣᵢXᵢⱼ<=Capacity of store i∀j in products
Maximum available products
   ΣᵢXᵢⱼ<=Availability of product j∀i in stores

### 4. Facility Mapping MIP Formulation

Sets: I: set of facilities, J: set of terminals
Parameters: Cᵢⱼ: Cost of assigning a terminal to a facility
Decision variables: Xᵢⱼ={0,1}∀i in facilities, j in terminals
   =1 if facility j is assigned terminal i
   =0 otherwise
Objective function: Minimize Σ₍ᵢ₎Σ₍ⱼ₎Cᵢⱼ*Xᵢⱼ
Constraints:
Maximum number of facilities assigned to a terminal
   ΣᵢXᵢⱼ<=Max i∀j in terminals
Maximum number of terminals assigned to a facility
   ΣⱼXᵢⱼ<=Max j∀i in facilities

### 5. Knapsack MIP Formulation

Sets: I: set of products
Parameters: Cᵢ: Cost of carrying product i in the knapsack
   Wi: Weightof, W: Maximum weight the knapsack can carry
Decision variables: Xᵢ={0,1}∀i in products
   =1 if product i is selected
   =0 otherwise
Objective function: Minimize Σ₍ᵢ₎Cᵢ*Xᵢ
Constraints: Weight constraint of the knapsack: ΣiWi*Xi≤W

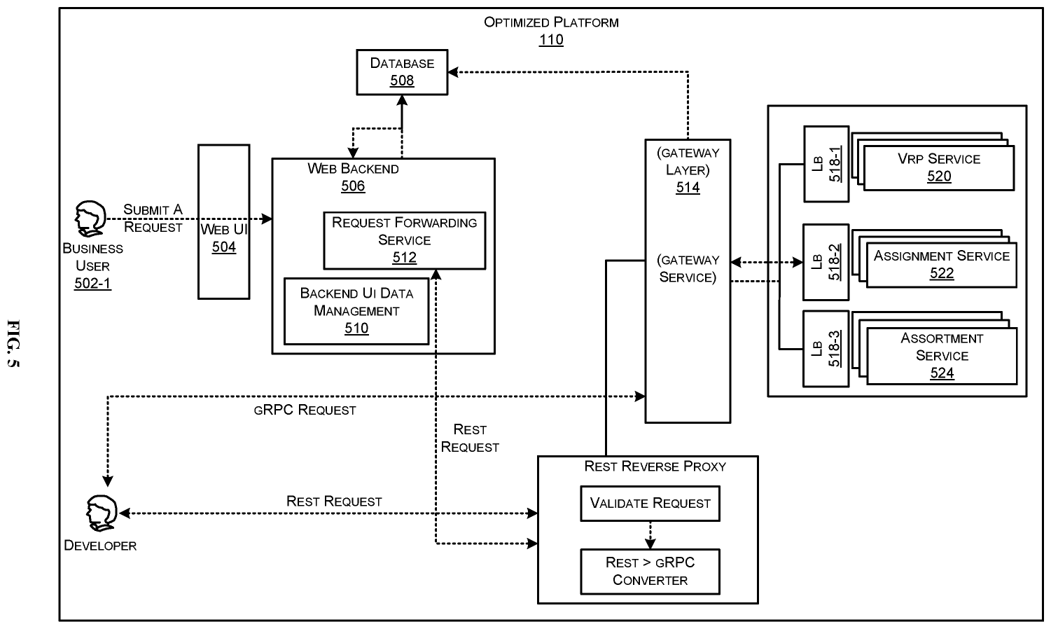

FIG. 5 illustrates an exemplary representation (500) of an HLD component, in accordance with an embodiment of the present disclosure.

As illustrated, in an aspect, the components of HLD may include a Web Backend (506) that has a Backend UI Management (510) that powers the Web App UI with APIs to show UI cards, provides developer Options such as Rich Text Description, IO format, Driver code to execute an API. The Backend UI management has the APIs for all the different type of UI cards such as “Business Use case templates”, “Custom Use case Templates”.

In an exemplary embodiment, optimization platform/system (110) may have a Backend UI (user interface) management system (510) to manage the request received by the users (104). The user may submit a request through the Web UI (504) using the computing device (104). The user may be a Business user (502-1) or a Developer user (502-2). The Backend UI management system (510) may be configured with a database (508) to store information regarding the users (102) request and record the execution of the requests. The Backend UI management system (510) may also be configured with a Request Forwarding Service (512) to receive the request from the users (102) and forward it to a Rest Reverse Proxy Server (516) which converts the request from JSON to gRPC request and sends it for execution.

In an exemplary embodiment, the Backend UI management system (510) may have APIs for keeping the record of a user's history and the execution of requests. The Backend (506) may further include a Request Forwarding Service (512) that may take responsibility of forwarding the request from the user to the Rest Reverse Proxy Server (516). The Rest Reverse Proxy Server (516) may convert the request from JSON to gRPC request and send it for execution.

The Rest Reverse Proxy Server (516) may have HTTP/HTTPS JSON REST endpoints, to accept the request and convert it into corresponding gRPC request. It may further send the gRPC to the API Gateway for execution. The Rest Reverse Proxy Server (516) may act like an entry point for the request presented for a JSON endpoint. The Rest Reverse Proxy Server (516) may take care of some basic validation tasks such as headers, logging, access to template files and passes or rejects the request.

The high level diagram (HLD) may further include a Gateway Layer (514) that may have an Entry point for gRPC services to be considered for execution. The Gateway Layer (514) may act like a gatekeeper to validation, authentication, rate limiting and logging metrics for every request coming for execution in the system. The Gateway Layer (514) may be configured with a service registry (520, 522, 524), that contains a list of all the services running the optimized platform/system (110) with execution points. The service registry may include the VRP service (520), Assignment service (522) and the Assortment service (524). A Gateway service configured in the Gateway layer (514) that routes the request to specific services. The Gateway Layer (514) accepts a gRPC request, routes the request for execution.

The HLD may further include an Execution Layer (602) that hosts variety of services as per the different problem types such as VRP, Assignment, Assortment, Facility mapping, Inventory, Scheduling, Inventory, Knapsack. The common input for the services includes Data Section (data for use case such as vehicle and nodes info in case of VRP, Worker and task info in case of Assignment) and Config Section: this includes additional details required to solve the problem like.
Tools: Can the problem be solved using Pulp, CPlex, GA, SA etc.
Formulation: MIP, Non-Linear, Constraint Programming, Metaheuristics.
Additional Constraint Properties: As per the different problem types, there can be additional fields such as time limit, max time per vehicle, slack and the like. These are captured by the additional properties section.

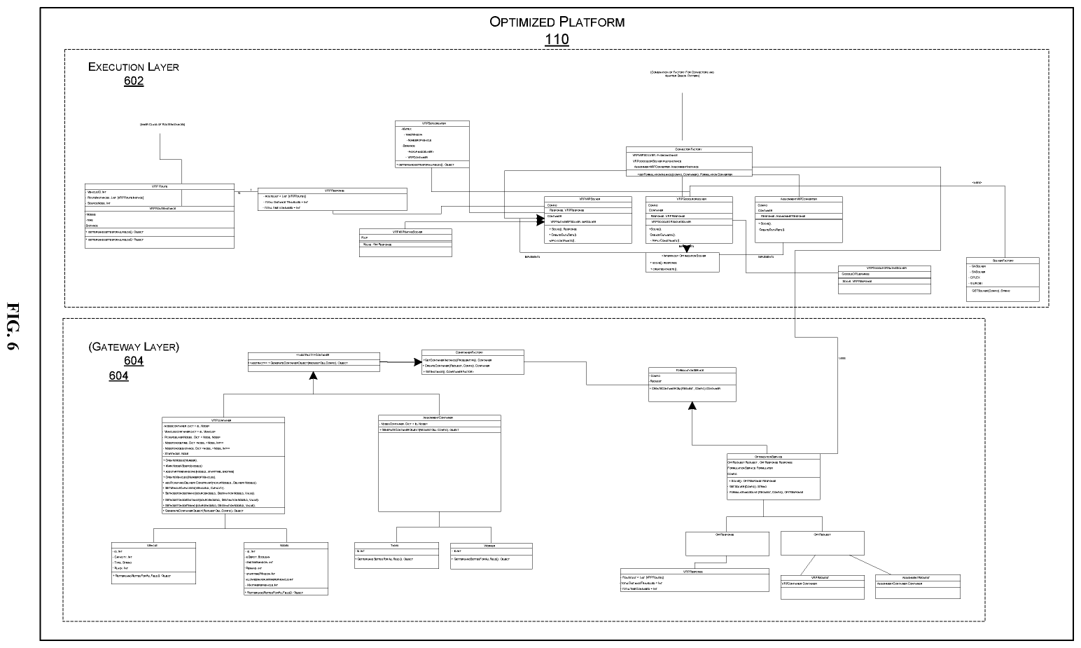

FIG. 6 illustrates an exemplary representation of an LLD system (600) in accordance with an embodiment of the present disclosure. As illustrated, the LLD system (600) can have at least two layers within the system, Execution Layer (602) and Gateway Layer (604). The Gateway Layer (604) comprises of the services which reads request job from the users (102), validates the request and forwards to the Execution Layer (602. The Execution Layer (602) can host different services that carry out responsibilities for different problem types such as VRP, Assignment, Assortment and the like.

The Execution Layer (602) may receive the input from Gateway layer (604), and convert the input into the language to be processed by the one or more tools used by the optimized platform (110). Once the solution is ready, it may be available in the native libraries of the solver (tools) as Pulp Library for MIP based problems, Google OR instance for Metaheuristics with Google OR based problems etc. This solution is then converted into an output format as per the API contract, and returned back to Gateway Layer (514).

In an exemplary embodiment, the Gateway Layer (602) may include an Optimization Service (660) as the entry point of the application. The Server thread provides the Input object OptRequest (664) to analyse and execute the request. After successful completion of the request, it returns the OptResponse (662) object back to the caller of the request.

In an exemplary embodiment, the OptRequest (664) may be a super class for all the different input objects that the Optimization Service (660) can solve. Every specific problem type may inherit from the OPTRequest class. Each OptRequest object may have a data section, specifying the data requirement and a config section for specifying the configurations required to solve the problem. For example, in case of a VRP problem type, the VRP Request inherits form the OptRequest class.

In an exemplary embodiment, the OptResponse (662) can be a response super class containing response of each different problem types associated with the problem. In the case of VRP problem type, the object of VRP Response may be generated of type OptResponse.

In an exemplary embodiment, a Formulation Service (658) may handle validation, parsing the OptRequest object and generate specific containers for each problem type associated with the problem. Along with container generation, it may also take care about the containers which are custom data structures classes for different problem types that can be floated across the system. The Formulation Service (658) may use the Container Factory (654) class to generate Container Objects (652).

In an exemplary embodiment, the Container Factory (654) may generate the Container Objects (652) from the OptRequest (664) as per the different problem types. For example, for the VRP Problem type, a VRP Container (656) may be a container class for VRP type problems. It may consist of, objects of vehicles and nodes along with details such as vehicleID, vehicle capacity, node id, node pickup/drop information, node to node distance, node to node time required. Similarly for other problem types like Assignment, an Assignment Container (658) may create Tasks (670) and Worker objects (672).

In an exemplary embodiment the Execution Layer (602) may include a Converter Factory (620) that may act like an instance generator class to create objects of problem type, method solver instances (tools). The solver instances (616, 618, 622, 626) utilize the Converter Factory (620) to provide solutions. The solvers contain composition of the Native Solver Objects and the interface methods that take the responsibility of implementation of creating sets, applying the constraints, and solving the problem using native libraries. For example, the solver instances may include VRPMIPSolver (618), VRPMIP Native Solver (616), VRPResponse (612). As an example but not as a limitation, if we take VRPMIP problem type, there will be a VRPMIP Solver instance, which will have a VRPMIPNative Solver as native solver instance. VRPMIP's create datasets, variables, as per the MIP library understands. Alternatively, VRPMIP's solve method implementation runs the native solver, and formats the output in the form of a VRPResponse object. Since VRPResponse is a type of OptResponse instance, it returns back the OptResponse object.

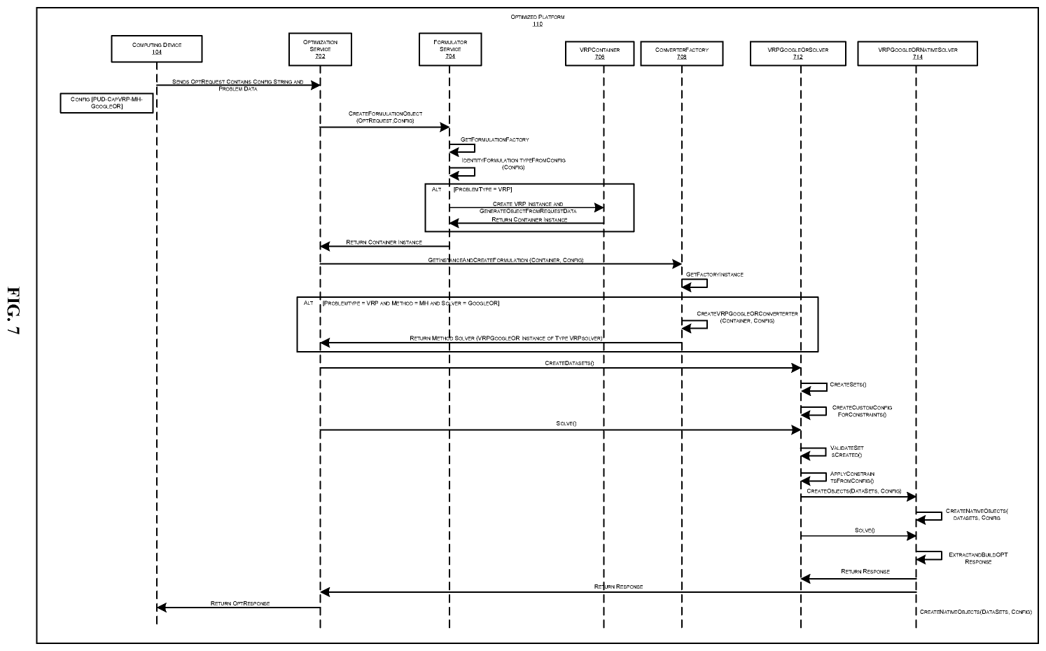

FIG. 7 illustrates an exemplary representation (700) of a sequence diagram (700), in accordance with an embodiment of the present disclosure.

The sequence diagram as shown in FIG. 7 shows that the users (102) may submit a request job via UI or Developer API. An example can be taken as a request with features such as
Constraints: Pickup & Delivery
Problem: VRP Problem
Method: Metaheuristics
Tools: Google OR

The Optimization Service (702) may receive the OptRequest when a request is submitted by the users (102) through the computing device (104). The Optimization Service (702) may invoke the solve method (tools), which may further invoke the Formulation Service, to create container objects and validate the request.

The Formulation Service (704) may validate the input, create the respective container objects using the Container Factory, Abstract Container Class and problem type Container classes. Like VRP Container (706) and Vehicle, Node classes. This uses a Factory Design pattern to create Container Objects based on the config supplied in the OptRequest, and returns an object of Vehicle Container of Type Container class, and is returned back to the Optimization Service.

The Optimization Service's (702) solve may perform the following things:
a. It may Initiate the converter Factory (708) instance
b. It may create the native solver object of type Optimizer Solver Class:
i. This ensures that all the native Solvers like VRPMIPSolver, VRPGoogleORSolver, AssignmentMIP etc have two main methods implemented such as create DataSets and solve.

VRPMIPSolver (710) executes the create Datasets method which internally creates sets which the native MIPsolver understands. In this case of MIP Problem, it creates sets based on pulp formulations based on the container selected in the config object. Additionally, the VRPMIPSolver executes the solve method which internally runs the Native MIPsolver and returns the VRPResponse object of OptResponse. In this case of MIP Problem, the Native Solver solves the MIP formulation and creates output as the sequences of nodes as routes for all vehicles. Wraps into VRPResponse and returns as OptResponse Object. This Response is returned back to Optimization Service and then cascaded as response of Object to the job request.

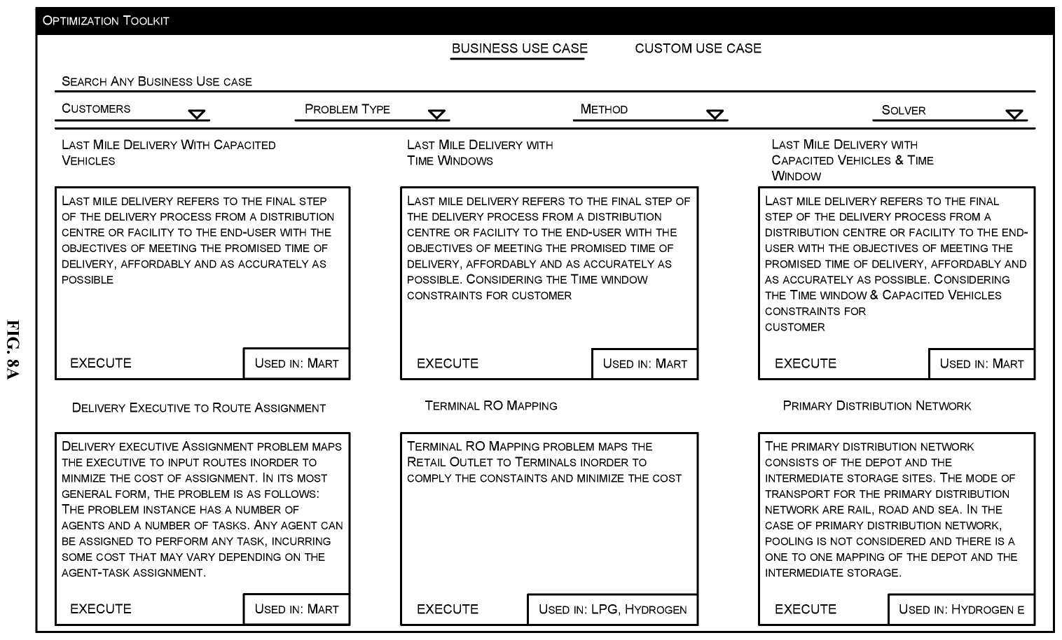

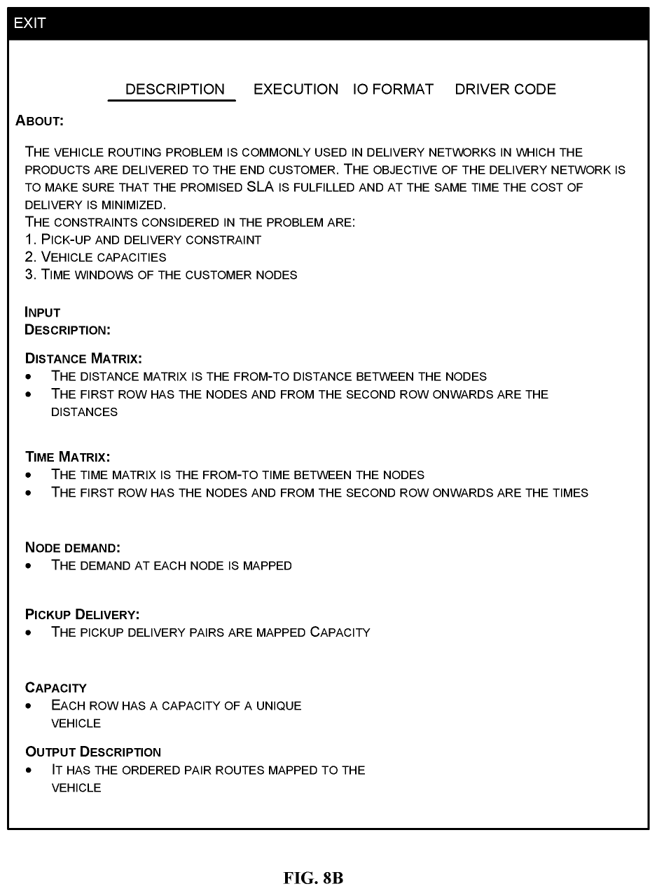

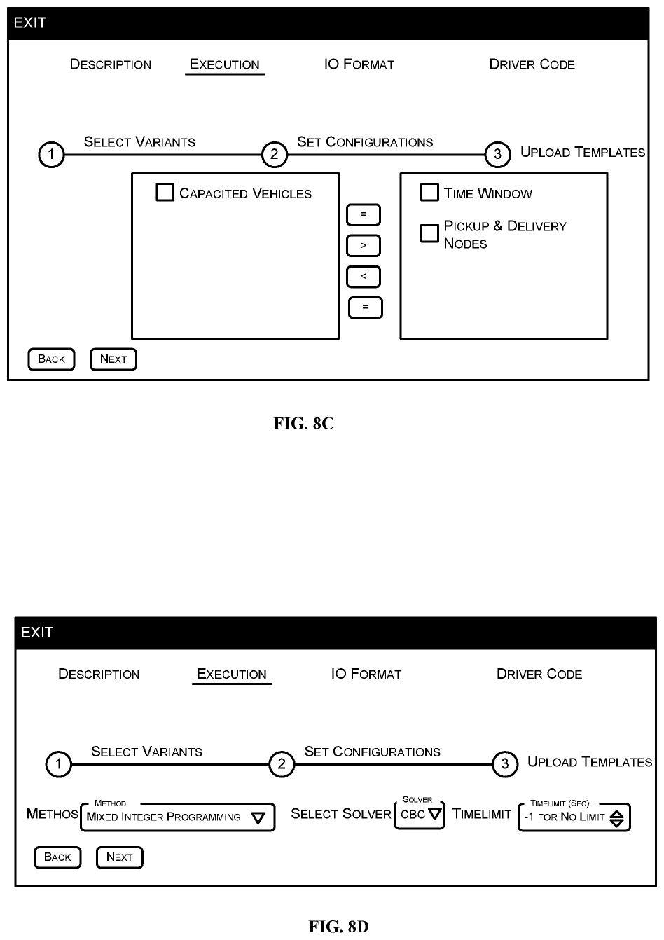

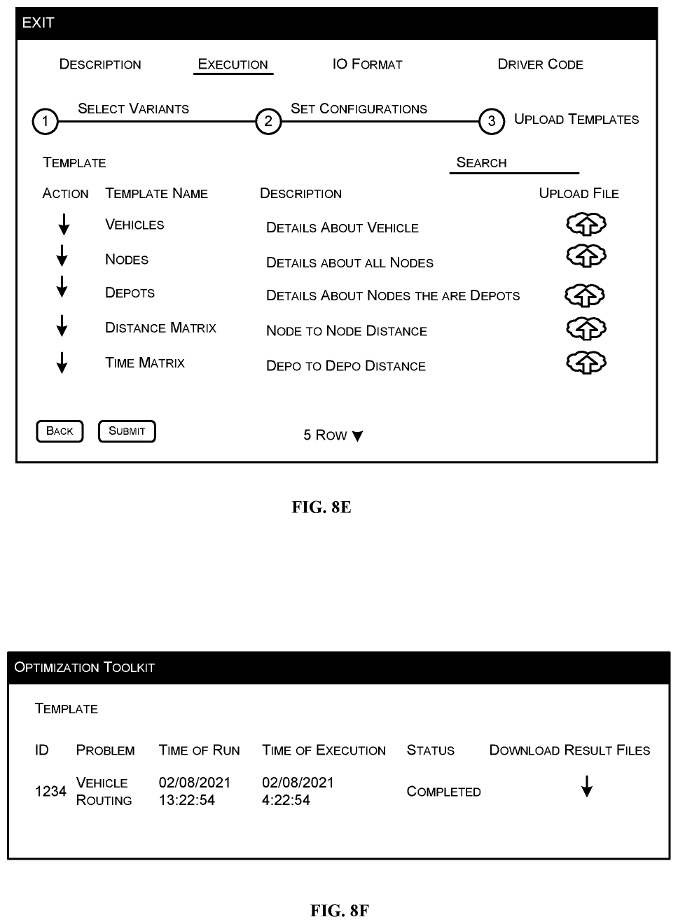

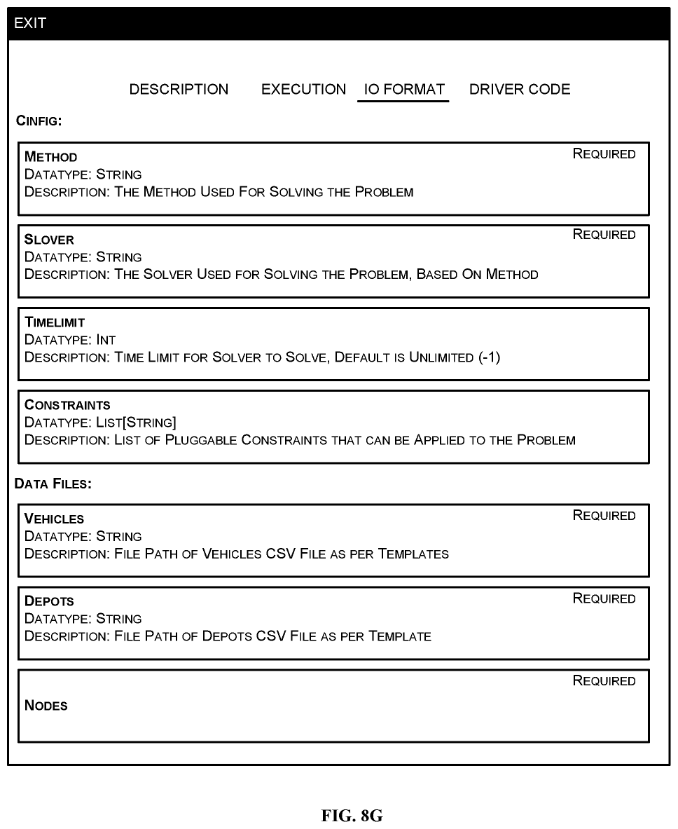

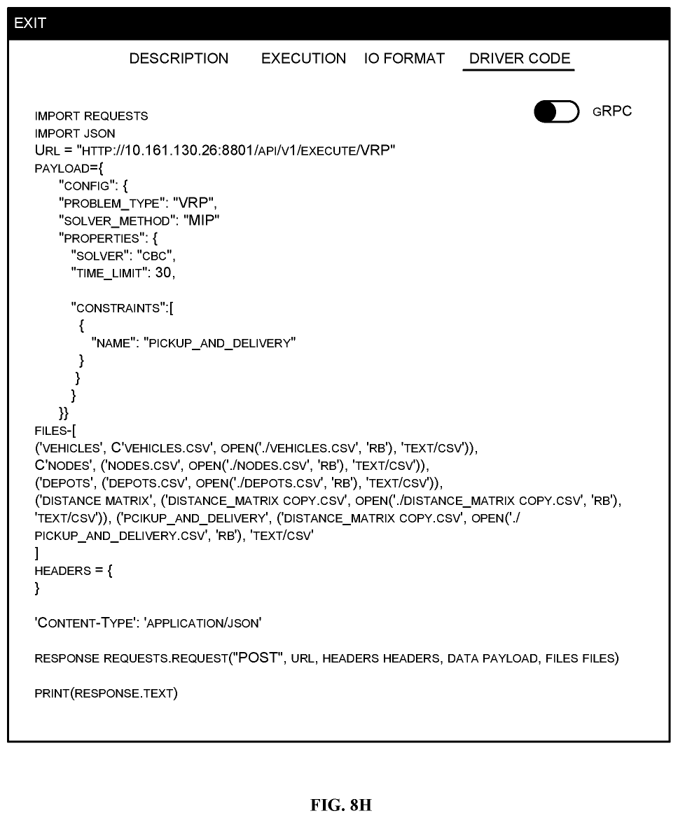

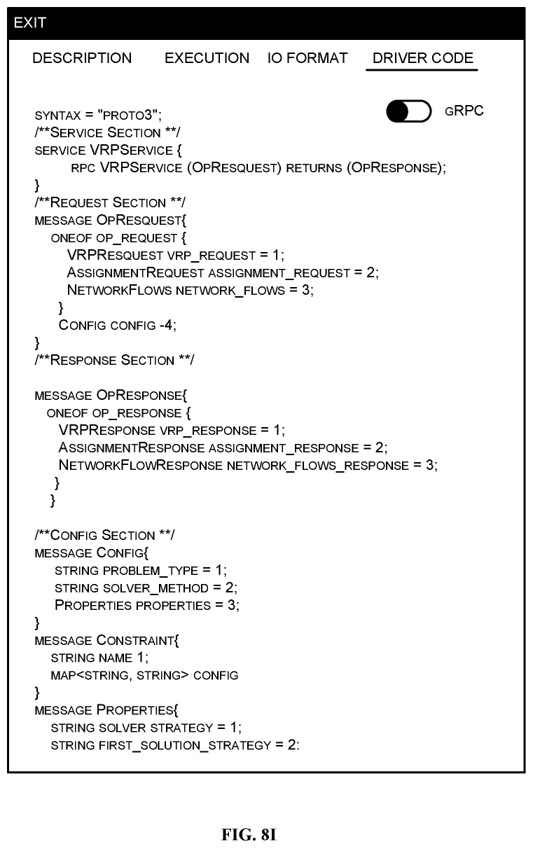

FIGS. 8A-8I illustrate exemplary representations of user interface (UI) screens, in accordance with an embodiment of the present disclosure. As illustrated in FIG. 8A a home screen for the UI is shown. As illustrated, FIG. 8B shows the execution wherein the users (102) can select constraints that can applied to a Custom use case card, to customize the problem “Business Use case” cards in the system. Users (102) can use the computing device (104) and search the card by the title. They can also filter the set of cards based on customer, problem type, method type and solver. Each card has a title demonstrating the business or Operational Research problem they are trying to solve. There are at least two types of API Cards such as Business Use case and Custom Use case. The users (102) may populate the fields such as “Customers”, Problem Type, Method and the “Solver”. The optimized platform (110) may process these input parameters and produce a custom solution, shown as widgets in FIG. 8A.

In an exemplary embodiment, the Business Use case can be business tailored solutions designed for a specific problem as illustrated in FIG. 8B. It may have a description about the problem, in both short text as well as a rich text format. It may display the input parameters provide by the users (102) such as the distance matrixes, time matrix, node demand, pick up/delivery and capacity for the problem type. It may also display the predefined constraints provided by the users (102). An output display statement specifying the custom solution provided the optimized platform/system (110) may also be shown.

FIG. 8C shows a Configuration Selection to select different methods, and config settings available for execution. The Custom Use case card may enable users (102) to solve the problem by choosing the option which provides the best solution. In this case, the execution of the custom use case card may be similar to the ones of the business user, but with additional components such as
c. Method: Can choose from available OR formulation methods such as MIP, Non Linear, Meta Heuristics etc.
d. Solver: Choose solvers after choosing the methods
e. Time limit: Time limit to limit solving the problem.
f. Templates: Based on the selected options, user gets the templates (csv files) to be filled and submitted.

FIG. 8D shows an Execution Tab that enables users (102) to input the method for solving the problem type, the solver and the time limit to execute the problem.

FIG. 8E shows a dashboard to download results of submitted problem types. Once submitted, the request is taken into consideration for execution by the optimized platform (110). FIG. 8F shows the problem type selected by the users (102), along with the status of the problem type. It also provides the time of run and the time taken for execution specific to the problem type.

FIG. 8G displays information about the IO Format tab with emphasis on the configuration and data files provided by the users (102). The configuration may include the method, solver, time limit and the constraints provided. It may also include the data files provided by the users (102).

FIGS. 8H and 8I represent the driver used by the optimized platform/system (110) to generate the customized solution for the problem type. The Driver Code displays python code, as guidance for the users (102) to consume the API pragmatically.

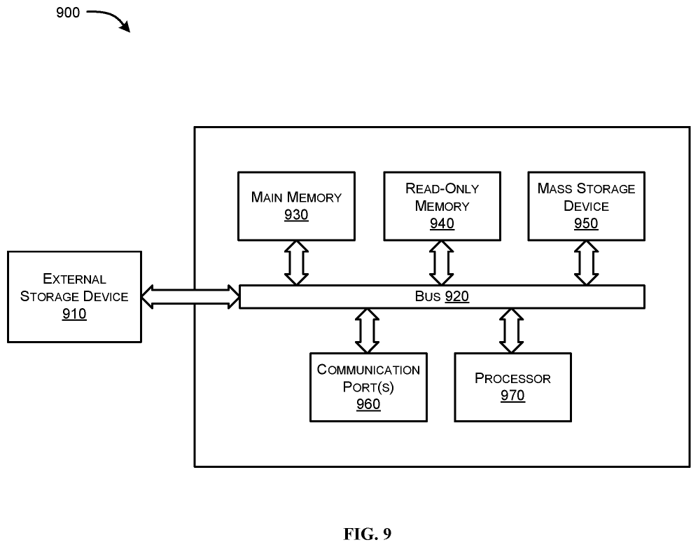

FIG. 9 illustrates an exemplary computer system (100) used in accordance with an embodiment of the present disclosure. As shown in FIG. 9, the computer system (900) can include an external storage device (910), a bus (920), a main memory (930), a read only memory (940), a mass storage device (970), communication port (960), and a processor (970). A person skilled in the art will appreciate that the computer system may include more than one processor and communication ports. Processor (970) may include various modules associated with embodiments of the present invention. Communication port (960 can be any of an RS-232 port for use with a modem based dialup connection, a 10/100 Ethernet port, a Gigabit or 9 Gigabit port using copper or fiber, a serial port, a parallel port, or other existing or future ports. Communication port (960) may be chosen depending on a network, such a Local Area Network (LAN), Wide Area Network (WAN), or any network to which computer system connects. Memory (930) can be Random Access Memory (RAM), or any other dynamic storage device commonly known in the art. Read-only memory (940) can be any static storage device(s) e.g., but not limited to, a Programmable Read Only Memory (PROM) chips for storing static information e.g., start-up or BIOS instructions for processor (970). Mass storage (950) may be any current or future mass storage solution, which can be used to store information and/or instructions.

Bus (920) communicatively couples processor(s) (970) with the other memory, storage and communication blocks. Bus (920) can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor (970) to software system.

Optionally, operator and administrative interfaces, e.g. a display, keyboard, joystick and a cursor control device, may also be coupled to bus (920) to support direct operator interaction with a computer system. Other operator and administrative interfaces can be provided through network connections connected through communication port (960). Components described above are meant only to exemplify various possibilities. In no way should the aforementioned exemplary computer system limit the scope of the present disclosure.

Thus, the present disclosure provides a unique and inventive solution for optimising non-linear process units, which are currently only being optimized using gradient-free linear methods which do not capture non linearities. An optimization system/model using Artificial Intelligence helps manage operations in its true nature of state, capturing dynamic interactions of all the measured variables in input and output space. Using such system in plant operations may provide maximum productivity and efficiency from its assets.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### ADVANTAGES OF THE PRESENT DISCLOSURE

The present disclosure provides a system and a method to facilitate a one-stop place for customizing optimization solutions for various entities.

The present disclosure provides a system and a method to facilitate delivery planning, order scheduling, inventory optimization and product allocation.

The present disclosure provides a system and a method to enable business decision makers, planners and other non-technical users to solve optimization problems in the supply chain, distribution network, services, scheduling and delivery systems.

The present disclosure provides a system and a method to enable a non-optimization and non-operation research user to solve optimization problems in the supply chain, distribution network, services, scheduling and delivery systems.

We claim:

1. An optimized platform (110) for providing an customized solution for a predefined problem, the optimized platform comprising:
one or more processors (202) operatively coupled to a plurality of computing devices (104), the one or more processors (202) coupled with a memory (204), wherein said memory (204) stores instructions which when executed by the one or more processors (202) causes said system (110) to:
receive one or more input parameters from one or more users (102) using a predefined template, wherein the one or more users (102) operate through the plurality of computing devices (104) connected to each other through a network (106), wherein the one or more users (102) are associated with an entity (120);
extract a first set of attributes from the one or more input parameters, the first set of attributes pertaining to predefined constraints provided by the one or more users (102) for the entity (120);
extract a second set of attributes based on the first set of attributes, the second set of attributes pertaining to one or more techniques associated with the problem, selected by the one or more users (102) for the entity (120);
extract a third set of attributes based on the second set of attributes, the third set of attributes pertaining to one or more tools associated with the one or more techniques, selected by the one or more users (102) for the entity (120);
based on the first set of attributes, the second set of attributes and the third set of attributes, generate an optimized model through an AI engine (216), wherein the AI engine (216) is configured to use the one or more tools and the one or more techniques; and
auto-recommend, the customized solution for the predefined problem, based on the optimized model.

2. The optimized platform (110) as claimed in claim 1, wherein the optimized platform is further configured to: generate an authentication token to enable the one or more users (102) to access the predefined template.

3. The optimized platform (110) as claimed in claim 1, wherein the one or more techniques used by the AI engine (216) includes any or a combination of Linear program (LP) (346), Mixed Integer Programming (MIP) (350, 352), Quadratic Programming (QP) (348) and metaheuristics (MH) (356).

4. The optimized platform (110) as claimed in claim 1, wherein the one or more tools used by the AI engine (216) includes any or a combination of Genetic Algorithms (GA) and Simulated Annealing (SA) to execute the one or more techniques.

5. The optimized platform (110) as claimed in claim 1, wherein the optimized platform is configured to: classify the one or more input parameters into a problem type associated with the problem using the one or more tools and the one or more techniques.

6. The optimized platform (110) as claimed in claim 1, wherein the optimized platform is further configured to: enable the one or more users (102) to add an additional set of parameters with the one or more input parameters to generate a customized template, wherein the additional set of parameters pertain to additional constraints provided by the one or more users (102) for the entity (120).

7. The optimized platform (110) as claimed in claim 1, wherein the optimized platform is further configured to use the customized solution to optimize a set of routes for a fleet of heterogeneous vehicles for the entity (120).

8. The optimized platform (110) as claimed in claim 1, wherein the optimized platform is further configured to use the customized solution to allocate resources for the entity (120).

9. The optimized platform as claimed in claim 6, wherein the optimized platform is further configured to use the customized solution to schedule a task for the entity (120) based on the additional constraints through the customized template.

10. The optimized platform as claimed in claim 1, wherein the optimized platform is further configured to use the customized solution to minimize the cost and achieve the desired product blend for the entity (120).

11. The optimized platform as claimed in claim 1, wherein the optimized platform is configured to use the customized solution to maximize profitability while creating a product assortment for the entity (120).

12. The optimized platform as claimed in claim 1, wherein the optimized platform is configured to use the customized solution to minimize the cost of packing materials for a given set of products for the entity (120).

13. The optimized platform as claimed in claim 6, wherein the optimized platform is further configured to operate in an asynchronous mode to:
enable the one or more users (102) to access the predefined template and generate the customized solution, through an API; and
enable the one or more users (102) to access the customized template and generate a modified customized solution, through the API.

14. The optimized platform as claimed in claim 1, wherein the optimized platform is further configured to:
record the one or more input parameters;
enforce validation, authentication, rate limiting and logging metrics for the one or more input parameters;
bifurcate the one or more input parameters and assign custom data structures to the one or more input parameters based on the problem type; and
create objects from the custom data structures to be integrated with the one or more tools to generate the customized solution.

15. The optimized platform as claimed in claim 1, wherein the one or more input parameters pertain to any or a combination of supply chain, distribution network, services, scheduling and delivery systems.

16. The optimized platform as claimed in claim 1, wherein the entity (120) includes any or a combination of goods transport, retail offline, online organisation, telecom, hydrocarbons retail, manufacturing and polymer industry, and healthcare.

17. A user equipment (UE) (104) for customized solution for a predefined problem, said UE comprising:
one or more processors (206), the one or more processors (206) coupled with a memory (208), wherein said memory (208) stores instructions which when executed by the one or more processors (206) causes said user equipment (UE) (104) to:
receive one or more input parameters from the one or more users (102) using a predefined template;
transmit the predefined template populated with the one or more input parameters to an optimized platform (110), wherein the user equipment (UE) (104) is communicatively coupled to the optimized platform (110);
receive, from the optimized platform (110), the customized solution for the predefined problem, wherein the optimized platform (110) is configured to:
extract a first set of attributes from the one or more input parameters, the first set of attributes pertaining to predefined constraints provided by the one or more users (102) for an entity (120);
extract a second set of attributes based on the first set of attributes, the second set of attributes pertaining to one or more techniques associated with a problem, selected by the one or more users (102) for the entity (120);
extract a third set of attributes based on the second set of attributes, the third set of attributes pertaining one or more tools associated with the one or more techniques, selected by the one or more users (102) for the entity (120);
based on the first set of attributes, the second set of attributes and the third set of attributes, generate an optimized model through an AI engine (216), wherein the AI engine (216) is configured to use the one or more tools and the one or more techniques; and
auto-recommend, the customized solution for the predefined problem, based on the optimized model.

18. A method (110) for providing an customized solution for a predefined problem, said method comprising:
receiving, by one or more processors (202), one or more input parameters from one or more users (102) using a predefined template, wherein the one or more users (102) operate through a plurality of computing devices (104) connected through a network (106), wherein the one or more processors (202) are operatively coupled to a plurality of computing devices (104), and coupled with a memory (204), wherein said memory (204) stores instructions to be executed by the one or more processors (202);
extracting, by the one or more processors (202), a first set of attributes from the one or more input parameters, the first set of attributes pertaining to predefined constraints provided by the one or more users (102) for an entity (120);
extracting, by the one or more processors (202), a second set of attributes based on the first set of attributes, the second set of attributes pertaining to one or more techniques associated with a problem type, selected by the one or more users (102) for the entity (120);
extracting, by the one or more processors (202), a third set of attributes based on the second set of attributes, the third set of attributes pertaining one or more tools associated with the one or more techniques, selected by the one or more users (102) for the entity (120);
generating, by the one or more processors (202), based on the first set of attributes, the second set of attributes and the third set of attributes, an optimized model through an AI engine (216), wherein the AI engine (216) is configured to use the one or more tools and the one or more techniques; and
auto-recommending, a customized solution to provide an optimization platform across a plurality of domains, based on the optimized model.

19. The method as claimed in claim 16, the method further comprising:
recording, by the one or more processors (202), the one or more input parameters;
enforcing, by the one or more processors (202), validation, authentication, rate limiting and logging metrics for the one or more input parameters;
bifurcating, by the one or more processors (202), the one or more input parameters;
assigning, by the one or more processors (202), custom data structures to the one or more input parameters based on the problem type; and
generating, by the one or more processors (202), objects from the custom data structures to be integrated with the one or more tools to generate the modified customized solution.

20. The method as claimed in claim 16, wherein the one or more techniques used by the AI engine (216) includes any or a combination of Linear program (LP) (346), Mixed Integer Programming (MIP) (350, 352), Quadratic Programming (QP) (348) and metaheuristics (MH) (356).

21. The method as claimed in claim 16, wherein the one or more tools used by the AI engine (216) includes any or a combination of Genetic Algorithms (GA) and Simulated Annealing (SA) to execute the one or more techniques.

22. The method as claimed in claim 16, wherein the one or more input parameters pertain to any or a combination of supply chain, distribution network, services, scheduling and delivery systems.

23. The method as claimed in claim 16, wherein the entity (120) includes any or a combination of goods transport, retail offline, online organisation, telecom, hydrocarbons retail, manufacturing and polymer industry, and healthcare.
